(19) United States
(12) Patent Application Publication
(10) Pub. No.: US 2007/0068357 A1
(43) Pub. Date: Mar. 29, 2007

(54) Interchangeable blade sheet cutter

(76) Inventor: Deborah J. Marin, Mokena, IL (US)

Correspondence Address: KNECHTEL, DEMEUR & SAMLAN, 525 W. MONROE STREET, SUITE 2360, CHICAGO, IL, 60661, US

(21) Appl. No.: 11/237,465

(22) Filed: Sep. 28, 2005

(51) Int. Cl. B26D 1/30

(52) U.S. Cl. 83/607

(57) ABSTRACT

An interchangeable blade guillotine sheet cutter includes a main board for supporting the sheet material and an interchangeable cutting means. The main board has a raised base with at least one edge for supporting the sheet to be cut. Releasable retaining means hold the interchangeable cutting means to the main board. An example of releasable retaining means is at least one protrusion, preferably at least one hook, mounted on the edge of the main board that are received by openings in the base blade. The interchangeable cutting means is composed of a base blade and a movable blade pivotally attached to each other on one end. The two blades are preferably connected to each other by an elongated fastener means for separating the blades from each other while securely attaching the blades in pivoting relationship to each other. The two blades have cutting edges that are complementary to one another and various decorative designs may be formed into the blades. The decorative design of the blades will result in a decorative design on the cut sheet material. The interchangeable cutting means is designed to easily detach and reattach, preferably as a unit, from the main board. When properly installed, the base blade is flush with the upper surface of the raised base of the main board.

### BACKGROUND OF THE INVENTION

The present invention provides a guillotine sheet cutter with quickly interchangeable blades, and more particularly, to a guillotine paper cutter with interchangeable blades providing various decorative designs.

A hobby called scrap booking is gaining in popularity. Scrap books are made using photographs and other personal mementos which are assembled into a book. For decoration, the items are cut with decorative edge designs. Scissors and rotary paper cutters with different cutting blades are used to create the edge designs. A problem is how to cut a long straight edge or decorative edge using a scissors or replicable decorative edges using a rotary paper cutter. The answer is to use a guillotine sheet cutter. However, no solution exists for decorative edges that can be easily varied on a guillotine paper cutter.

Prior art guillotine sheet cutters have a fixed base blade and a movable blade. These blades are usually straight edges. Since the blades were fixed in place, it was impossible to quickly and easily change the design cut into the sheet. FIG. 1 is an illustration of a generally used guillotine sheet cutter. In contrast, rotary paper cutters with interchangeable blades containing various designs have been previously known in the art.

FIG. 1 is a perspective view of a prior art guillotine paper cutter 10. The paper cutter includes a cutting member 11, a main board 12 for document placement, a base blade 13 fixed on the engaging side of the main board 12, and a cutting member 11 pivotally attached to the main board 12. The cutting member 11 includes a handle 15 attached to the movable blade 14. The handle 15 is used to lift the movable blade 14 so that the movable blade 14 engages the edge of the base blade 13 to cut the document.

A rotary paper cutter with interchangeable blades, such as the Edgemaster Trimmer 300 and the Dahle Rotary Hobby Trimmers Nos. 507 and 508, consists essentially of a base for document placement, a pressure pad, and a blade holder assembly. The pressure pad has a guide rail and gear track attached to its upper surface. A blade holder assembly has a outer shell slidably attached to the guide rail, a shaft rotatably attached to the shell, a circular blade attached to the shell, and a gear attached to the shaft. As the blade holder assembly is slid on the guide rail the gear engages with the gear track and rotates the shaft and blade to cut sheet material between the pressure pad and the base. To change the design of the cut, a different blade holder assembly with a different circular blade is attached to the guide rail.

It is desirable to have a guillotine sheet cutter with interchangeable blades. One advantage is that there are many designs that would not be possible to make with a rotary paper cutter. With a rotary paper cutter, the design must repeat if the paper being cut is longer than the circumference of the rotary paper cutter's circular blade. Secondly, with a guillotine paper cutter, the operator could be sure where in the design pattern the cut would start. With a rotary blade, it is hard to set the blade so that a wavy design always started in the same place. Third, a guillotine paper cutter uses a vertically applied force to do the cutting that for some operators is preferred over the sliding action of a rotary paper cutter.

### SUMMARY OF THE INVENTION

An interchangeable blade guillotine sheet cutter includes a main board for supporting the sheet material and an interchangeable cutting means. The main board has a raised base with at least one edge for supporting the sheet to be cut. Releasable retaining means hold the interchangeable cutting means to the main board. An example of releasable retaining means is at least one protrusion, preferably at least one hook, mounted on the edge of the main board that are received by openings in the base blade. The interchangeable cutting means is composed of a base blade and a movable blade pivotally attached to each other on one end. The two blades are preferably connected to each other by an elongated fastener means for separating the blades from each other while securely attaching the blades in pivoting relationship to each other. The two blades have cutting edges that are complementary to one another and various decorative designs may be formed into the blades. The decorative design of the blades will result in a decorative design on the cut sheet material. The interchangeable cutting means is designed to easily detach and reattach, preferably as a unit, from the main board. When connected, the base blade is flush with the upper surface of the raised base.

The releasable retaining means is used to install the interchangeable cutting means onto the main board. If the releasable retaining means is angled hooks on the edge of the raised base and openings in the base blade for receiving the protrusions, then the operator uses the following steps to install the interchangeable cutting means. First, while the movable blade is in the lowered or non-cutting position, the user aligns the openings in the base blade with the protrusions on the main board at an angle. Then the bottom edge of the interchangeable cutting means is pushed inward. When properly seated, the top of the base blade now lies flush with the surface of the main board. An optional tab or tabs retains the base blade against at the edge of the base. For removal of the interchangeable cutting means, the process is reversed.

The interchangeable blade guillotine sheet cutter is used in the same manner as the prior art guillotine sheet cutter is used. With the movable blade in the raised or cutting position, a sheet or sheets are inserted on the base and moved until the portion of the sheet to be removed extends beyond the base blade. The user presses down on the movable blade or the handle that is connected to the movable blade. As the movable blade is pressed down on the sheet, the sheet is cut with the decorative design of the blades.

Thus, it is an objective of this invention to provide a guillotine sheet cutter with quickly interchangeable blades of various designs. Different decorative designs are useful in arts and crafts activities such as scrapbooking, collage making, sign making, or bookbinding.

It is also an object to provide a guillotine paper cutter that is capable of making long straight cuts having a design therein. This is an advantage over scissors that have a difficult time in cutting along a straight line.

An additional objective of this invention is to allow for designs which would not be possible with a rotary paper cutter. With a rotary paper cutter, the decorative design cut will be repeating if the circumference of the circular blade is less than the document being cut. A guillotine sheet cutter is not so constrained and it is possible for there to be a totally different design on the bottom of the page than the top of the page. Moreover, with a guillotine sheet cutter, it is known exactly where the design will start; it is not so easy to control on a rotary paper cutter whether a wavy design will start with a cut to the left or the right of the axis of the guide rail. This is a real disadvantage if you need exact copies and cannot cut that many at the same time.

The guillotine design also has benefits over a rotary cutter with interchangeable blades. It is potentially capable of cutting more sheets at the same time. The force used to make a cut is vertically applied and for some operators preferred over the sliding motion of the rotary paper cutter, especially if many cuts must be performed.

### BRIEF DESCRIPTION OF THE DRAWINGS

FIG. 1 is a perspective view of prior art guillotine sheet cutter.

FIG. 2 is a perspective view of the interchangeable blade guillotine sheet cutter. The interchangeable cutting means is shown detached from the main board. Angled hooks on an edge of the raised base and openings in the base blade for receiving the hooks are shown as an example of releasable retaining means. The movable blade is shown in the closed or non-cutting position. The handle is shown detached from the interchangeable cutting means.

FIG. 3 is a perspective view of the interchangeable blade guillotine sheet cutter. An interchangeable cutting means with a wavy design is shown attached to the main board.

FIG. 4 is a perspective view illustrating the installation of the interchangeable cutting means when the releasable retaining means is angled hooks on an edge of the raised base and openings in the base blade.

FIG. 4A is a cross-sectional rear view of the installation shown in FIG. 4.

FIG. 5 is an exploded perspective view of the parts of the interchangeable cutting means.

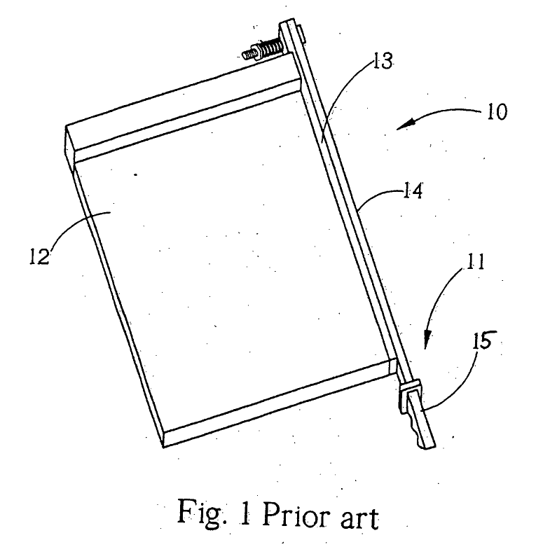

### DETAILED DESCRIPTION OF THE INVENTION

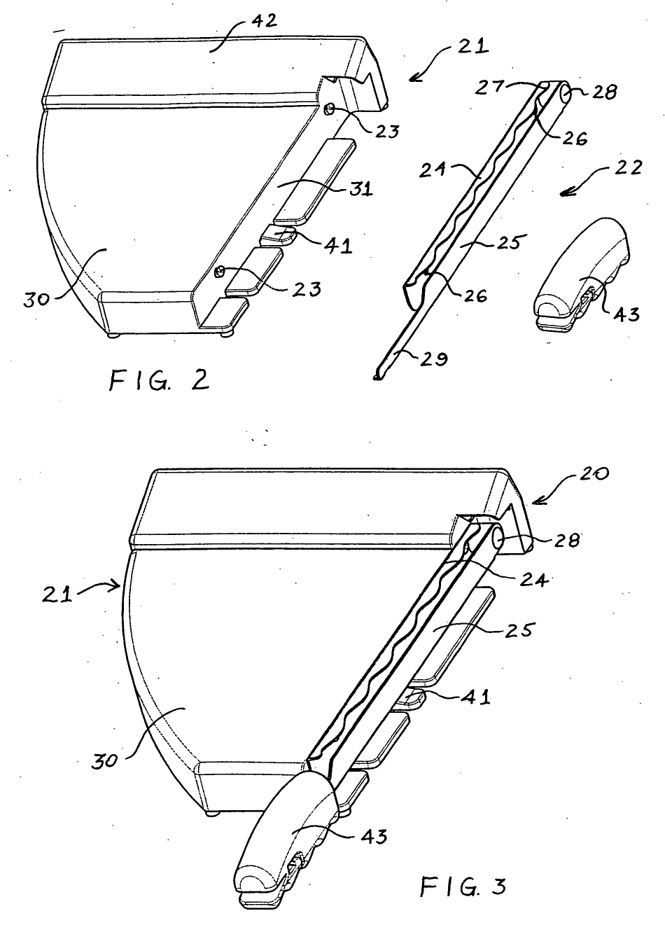

Turning first to FIGS. 2 and 3, there is illustrated an interchangeable blade guillotine sheet cutter 20 which includes a main board 21 and an interchangeable cutting means 22. The main board 21 consists essentially of a raised base 30 for supporting the sheet to be cut and at least one edge 31 and a top surface. On the at least one edge 31, there is releasable retaining means for releasably attaching the interchangeable cutting means 22 to the main board 21, preferably as a unit. As an example of releasable retaining means, the main board 21 may have at least one protrusion and/or at least one opening for receiving and holding in place the interchangeable cutting means 22.

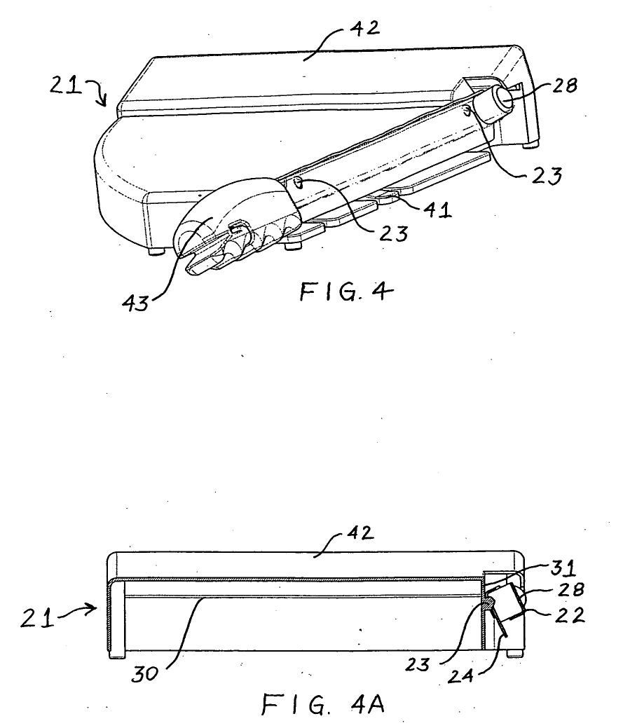

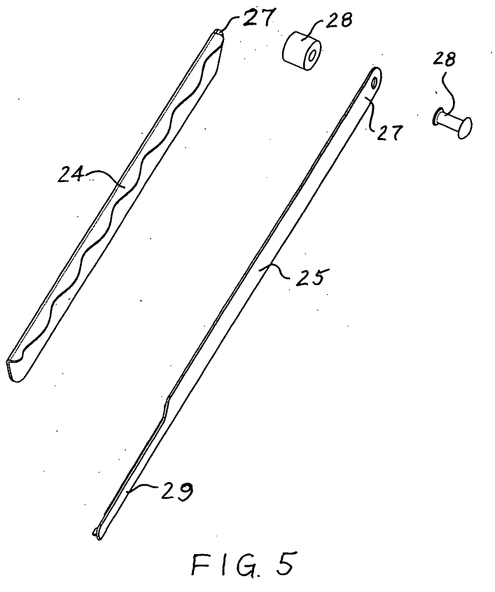

The raised base 30 is ideally made of plastic, including fiber reinforced plastic, but other materials such as wood or metal may be utilized. The left side (as viewed in FIG. 2) of the base can have multiple designs. The base may be rectangular in shape or may be curved on the left as shown in FIGS. 2, 3, and 4. The at least one protrusion on the base may include at least one hook 23 and optionally at least one tab 41. The optional tabs 41 may be spring-loaded and depressed during installation and detachment of the interchangeable cutting means 22. The at least one optional tab 41 on the at least one edge 31 on the main board 21 retains the base blade 24 against the at least one edge 31 of the main board 21. The at least one hook 23, as an example of at least one protrusion, may be upwardly angled as illustrated in FIGS. 2 and 4. Although the illustrations show two hooks 23 and two openings in the base blade 24 for receiving the hooks, there could be more or less. As an example of releasable retaining means, the base blade 24 may have at least one opening 26 in it that allows it to be quickly installed on to at least one protrusion, such as hooks, on the main board 21; these openings 26 are complementary to the protrusions on the main board 21. In an alternative embodiment, downward angled hooks may be attached to one edge of the base blade 24 and be received by openings in at least one edge of the main board 21. In addition to the base 30, a raised surface 42 is often attached at the top of the base to act as a guide for aligning the sheet as shown in FIGS. 2, 3, and 4. This raised surface 42 may optionally have ruler markings to aid the operator in cutting the paper to the desired size.

In addition to the hooks and openings described above in either the base blade or the edge of the main board, snap buttons or matching grooves and protrusions may be utilized as releasable retaining means. Grooves could be cut in the main board so that at least one protrusion mounted on at least one edge of the base blade 24 would slide into the main board 21 releasably attaching the interchangeable cutting means to the main board 21.

The interchangeable cutting means 22 is composed of both a base blade 24 and a movable blade 25, each with opposite ends. The base blade 24 and the movable blade 25 are preferably made of metal such as stainless steel, but may also be made of other metals, hard plastic or carbon fibers. The interchangeable cutting means 22 is designed to be easily detachably mounted to the main board 21 by the releasable retaining means. When connected, the top of the base blade 24 is flush with the upper surface of the raised base of the main board 21.

There are two positions for the movable blade 25: the lowered or non-cutting position and the raised or cutting position. In the non-cutting position, the movable blade 25 is in the depressed position as illustrated in FIG. 3. In the raised or cutting position, the movable blade 25 is raised, ready for the blade to be depressed and the paper below it cut.

The base blade 24 and the movable blade 25 have cutting edges for cutting the sheet material. The cutting edges are complementary to one another and various decorative designs may be formed into the cutting edges. These cutting edges of the base blade and the movable blade will create a decorative design on the sheet when the sheet is cut. Some designs include a traditional straight edge, a wavy or scalloped edge, or an edge consisting of various polygon shapes. As illustrated in FIG. 5, one end of the base blade 24 and one end of the movable blade 25 are pivotally attached together, preferably by an elongated fastener means 28 for separating the blades from each other while securely attaching the blades in pivoting relationship to each other. The elongated fastener means 28 maintains the base blade and the movable blade in spaced parallel relationship with each other. Examples of elongated fastener means include but are not limited to screws, bolts, and rivets.

The releasable retaining means is used to install, preferably as a unit, the interchangeable cutting means 22 onto the main board. It is also possible to install the base blade and then pivotally attach one end of the movable blade 25 to one end of the base blade 24. If the releasable retaining means is angled hooks 23 on the edge 31 of the raised base and openings 26 in the base blade 24 for receiving the protrusions, then the operator uses the following steps to install the interchangeable cutting means. First, while the movable blade 25 is in the lowered or non-cutting position, the user aligns the openings in the base blade 24 with the protrusions on the main board 21 at an angle. Then, the bottom edge of the interchangeable cutting means 22 is pushed inward. When properly seated, the top of the base blade now lies flush with the surface of the main board. The optional tab 41 or additional tabs retains the base blade against at the at least one edge of the base 30. For removal of the interchangeable cutting means, the process is reversed.

When the interchangeable cutting means 22 is installed on the main board 21, an operator can cut sheets by the following process: (a) placing the sheet to be cut on to the base of the main board 21; (b) placing the movable blade 25 into the raised cutting position; (c) moving the sheet to the right so that the paper to be removed is beyond the base blade 24; (d) pushing down on the movable blade 25, preferably with the handle 43. The cut paper having the decorative design formed by the cutting edges can then be removed from the guillotine paper cutter. Any unwanted paper scraps can be disposed of. Steps (a) and (b) can occur in any order. Multiple sheets may be substituted for the single sheet in the method above. Once the user finishes with one interchangeable cutting means 22, another can be installed to create a different decorative edge design.

In one embodiment, the handle 43 is releasably attached to the other end 29 of the movable blade opposite the end 27 that is attached to the one end of the base blade. Therefore, only one handle 43 is needed no matter how many interchangeable blade means 22 are used. Alternatively, a handle may be attached to the other end of the movable blade opposite the end that is attached to the one end of the base blade. It is also possible to use the other end 29 of the movable blade 25 as a handle. The handle is preferably made of plastic; however, it may be made of wood or metals such as aluminum or stainless steel. The handle 43 may be optionally coated with rubber or latex to prevent the hand from slipping.

Additional features well known in the art may also be added to the guillotine sheet cutter with quickly interchangeable blades. These may be added to the interchangeable cutting means or the main board. For example, a paper guide setting the maximum number of pages that can be cut at a single time can be attached to the main board or the base blade of interchangeable cutting means. Ruler markings or a grid may be placed on the main board. Optional safety devices may also be included with the invention.

Although the sheet cutter is illustrated and described with the cutting on the right, it would be possible to make a sheet cutter with the cutting done on the left. Such a design may be desirable in countries whose language is written right to left or for left-handed people.

Examples of sheets that could be cut on the interchangeable blade guillotine sheet cutter include, but are not limited to, copy paper, inkjet paper, laser paper, fax paper, photographic paper, filter paper, construction paper, card stock, paperboard, resume paper, business paper, newspaper, cardboard, acetate, fabric, plastic sheets, metal foil, matboard and foamboard

What is claimed is:

1. A cutter for cutting sheet material comprising:
a main board having at least one edge and a top surface for supporting the sheet material, interchangeable cutting means mounted to the main board for cutting the sheet material, releasable retaining means on the at least one edge for releasably attaching the interchangeable cutting means to the main board,
the interchangeable cutting means comprising a base blade and a movable blade, the base blade and the movable blade having opposite ends, one end of the base blade pivotally attached to one end of the movable blade, and
the base blade having a cutting edge and the movable blade having a complementary cutting edge for cutting the sheet material.

2. The cutter of claim 1 wherein one end of the base blade is attached to the one end of the movable blade by an elongated fastener means for separating the blades from each other while securely attaching the blades in pivoting relationship to each other.

3. The cutter of claim 2 wherein the interchangeable cutting means is attached to and removed from the main board as a unit.

4. The cutter of claim 2 wherein the releasable retaining means on the at least one edge comprises at least two protrusions mounted on the at least one edge that are received by two openings in the base blade.

5. The cutter of claim 2 wherein the releasable retaining means on the at least one edge comprises at least one protrusion that extends from the base blade that is received in the at least one edge.

6. The cutter of claim 2 and further comprising a handle attached to the other end of the movable blade opposite the end that is attached to the one end of the base blade.

7. The cutter of claim 6 wherein the handle is releasably attached to the other end.

8. The cutter of claim 4 wherein the protrusions are hooks.

9. The cutter of claim 1 wherein the base blade cutting edge and movable blade cutting edge create a decorative design on the cut sheet material.

10. The cutter of claim 1 and further comprising a tab on the at least one edge on the main board for retaining the base blade against the at least one edge of the base.

11. A paper cutter comprising:
a main board for positioning a sheet for cutting, the main board comprising a base with at least one edge, and at least one protrusions extending from the edge,
an interchangeable cutting means for removable attachment to the at least one edge comprising a base blade and a movable blade, the base blade and the movable blade pivotally attached to each other with an elongated fastener means, the base blade and the movable blade having cutting edges that are complementary to each other,
the interchangeable cutting means detachably mounted to the main board by the protrusion.

12. The paper cutter of claim 11 and further comprising at least two protrusions extending from the edge.

13. The paper cutter of claim 1 and further comprising at least one opening in the base blade that receives the protrusions.

14. The paper cutter of claim 11 wherein the elongated fastener means maintains the base blade and the movable blade in spaced parallel relationship with each other.

15. The paper cutter as in claim 11, wherein the interchangeable cutting means further comprises a handle that is releasably attached to the movable blade.

16. The paper cutter as in claim 11, wherein the protrusion is a hook.

17. The paper cutter as in claim 11 and further comprising at least one tab on the main board for retaining the base blade against the at least one edge of the base.

18. The paper cutter of claim 11 wherein the base blade and the movable blade create a decorative design on the sheet when the sheet is cut.
